(19) United States
(12) Patent Application Publication
(10) Pub. No.: US 2012/0251706 A1
(43) Pub. Date: Oct. 4, 2012

(54) METHOD OF MANUFACTURING AN ANTI-FINGERPRINT PAINT AND USE OF THE ANTI-FINGERPRINT PAINT

(76) Inventor: Chih-Hao Huang, New Taipei (TW)

(21) Appl. No.: 13/074,000

(22) Filed: Mar. 28, 2011

(51) Int. Cl. B05D 5/00; B05D 3/02; B05D 7/00; B05D 7/14; C08K 3/22; C08K 3/08; C09D 185/00; B05D 1/18; B05D 7/02; B82Y 40/00; B82Y 99/00

(52) U.S. Cl. 427/58; 427/385.5; 427/383.1; 427/389.7; 427/388.1; 427/393.5; 524/430; 524/439; 524/500; 977/773; 977/892

(57) ABSTRACT

A method of manufacturing the anti-fingerprint paint is described hereinafter. Firstly, blend fluorinated polymer with fluorocarbon solvents to form fluorocarbon polymer paint. Secondly, blend nano-particles with the fluorocarbon solvents, then add the fluorine-couplant into the fluorocarbon solvents with the nano-particles therein, and further mix up the above-mentioned solvents to get a nano-particle solvent. Lastly, blend the fluorocarbon polymer paint with the nano-particle solvents and further mix up the mixture of the fluorocarbon polymer paint and the nano-particle solvents under a room temperature for 12 to 24 hours to form the anti-fingerprint paint. The method of forming the anti-fingerprint coating onto the surface of the substrate is described hereinafter. Firstly, coat the anti-fingerprint paint onto a surface of the substrate. Secondly, heat the anti-fingerprint paint coated on the surface of the substrate to form the anti-fingerprint coating on the surface of the substrate.

### BACKGROUND OF THE INVENTION

1. Field of the Invention

The present invention relates to a method of manufacturing a paint, and more particularly to a method of manufacturing an anti-fingerprint paint and a use of the anti-fingerprint paint.

2. The Related Art

With the rapid development of electronic technology, various electronic apparatuses such as cell phones, personal and industrial computers, personal digital assistants, cameras and automated teller machines are universally used. In addition to enjoying more and stronger functions of the electronic apparatuses, consumers also expect the electronic apparatuses to be operated conveniently. So touching technology is widely used in the electronic apparatuses. As a result, shells and screens of the electronic apparatuses need have an anti-fingerprint characteristic.

Secretion of the human finger cortex mainly includes around 40% triglycerides, 25% wax monoesters, 15% free fatty acids, 12% squalene and 7% other substances. Because the substances described above are all oily, and furthermore the finger cortex is easily waterlogged. As a result, whether oil stains or water stains are apt to be adhered on touching surfaces of the electronic apparatuses.

In order to make the touching surfaces of the electronic apparatuses have an anti-fingerprint function, the electronic apparatuses must have characteristics of hydrophobic and oleophobic. As known in the art, discrepancies between the hydrophobic and oleophobic characteristics usually depend on differentiations of surface energies between the finger cortexes and the touching surfaces of the electronic apparatuses. Suppose the surface energy of the touching surface of the electronic apparatus is γc, and the surface energy of the stain on the finger cortex is γ. When γc≧γ, the stains adhered to the finger cortex are apt to be adhered to the touching surface of the electronic apparatus. When γc<γ, the stains adhered to the finger cortex is not apt to be adhered to the touching surface of the electronic apparatus. The surface energy of the water stain (γ) is 72 mN/m, and the surface energy of the oil stain (γ) is about 20˜40 mN/m. The surface energy of the most common material used to make the touching surface of the electronic apparatus, such as glass, metal, polyester, polyethylene and so on, is greater than 20 mN/m. So the water stain or the oil stain on the finger cortex of a user is liable to be adhered to the touching surface of the electronic apparatus made of the common material, so that causes a fingerprint of the user to be imprinted on the touching surface of the electronic apparatus. Therefore, a coating having a surface energy less than 20 mN/m is employed on a surface of a substrate such as glass, metal, ceramic and micromolecule material to prevent the fingerprint of the user from being adhered to the surface. The surface energy of fluoride is usually lower. The surface energy of polytetrafluoroethylene is about 20 mN/m, and the surface energy of cloflucarban(-CF3) is less than 10 mN/m, so the coating including fluoride can effectively prevent imprinting the fingerprint of the user on the surface.

USPAP 2006/0110537 issued on May 25, 2006 discloses an anti-fingerprint coating for application to a surface of a substrate. The anti-fingerprint coating is made of a hydrophobic nano-composite material, an oleophobic nano-composite material, or a super-amphiphobic nano-composite material. In fact, the hydrophobic nano-composite material may be a polymer nano-fiber, an organic silicon based nano-material, or the organic silicon based nano-material consisted of a fluorosilane. The anti-fingerprint coating made of the super-amphiphobic nano-composite material may have a super-amphiphobic carbon nanotube array to make the coating have the characteristics of hydrophobic and oleophobic.

The anti-fingerprint coating made of the super-amphiphobic nano-composite material realizes the characteristics of hydrophobic and oleophobic by means of the super-amphiphobic carbon nanotube array. However, a module or a special manufacturing technology is generally needed to assist the formation of the super-amphiphobic carbon nanotube array. Consequently, it's not convenient for mass manufacture.

### SUMMARY OF THE INVENTION

An object of the present invention is to provide a method of manufacturing an anti-fingerprint paint and a method of forming an anti-fingerprint coating onto a surface of a substrate. The method of manufacturing the anti-fingerprint paint is described hereinafter. Firstly, blend fluorinated polymer with fluorocarbon solvents to form fluorocarbon polymer paint. Secondly, blend nano-particles with the fluorocarbon solvents, then add the fluorine-couplant into the fluorocarbon solvents with the nano-particles therein, and further mix up the above-mentioned solvents to get a nano-particle solvent with an outside surface of each of the nano-particles dressed up by a layer of fluorinated molecules. Lastly, blend the fluorocarbon polymer paint with the nano-particle solvents and further mix up the mixture of the fluorocarbon polymer paint and the nano-particle solvents under a room temperature for 12 to 24 hours to form the anti-fingerprint paint. The method of forming the anti-fingerprint coating onto the surface of the substrate is described hereinafter. Firstly, coat the anti-fingerprint paint onto a surface of the substrate. Secondly, heat the anti-fingerprint paint coated on the surface of the substrate under 80 to 120 centigrade degrees for 0.5 to 2 hours, or air drying the anti-fingerprint paint coated on the surface of the substrate for 24 to 48 hours to make a functional base of fluorine-couplant in the anti-fingerprinted paint and a surface material of the substrate realize a chemical bonding so as to form the anti-fingerprint coating on the surface of the substrate.

As described above, the fluorinated polymer, fluorine atoms of the fluorine-couplant and the fluorinated molecules dressing up the nano-particles have low surface energies, and strict regular-arrayed spatial structure of the nano-particles achieves a spatial barrier, so that sweat or grease on fingers of a user is not liable to be adhered to the surface of the substrate. Therefore, a fingerprint of the user is prevented from being imprinted on the surface of the substrate. Furthermore, the methods of manufacturing the anti-fingerprint paint and forming the anti-fingerprint coating on the substrate are simple, and no expensive and special equipments are needed. As a result, an anti-fingerprint product has a lower manufacture cost and is apt to be mass manufactured.

### BRIEF DESCRIPTION OF THE DRAWINGS

The present invention will be apparent to those skilled in the art by reading the following description thereof, with reference to the attached drawings, in which:

FIG. 1 is a schematic, side view of an anti-fingerprint coating formed by coating an anti-fingerprint paint onto a substrate in accordance with an embodiment of the present invention.

### DETAILED DESCRIPTION OF THE PREFERRED EMBODIMENT

Reference will now be made to a drawing to describe an embodiment of the present invention in detail.

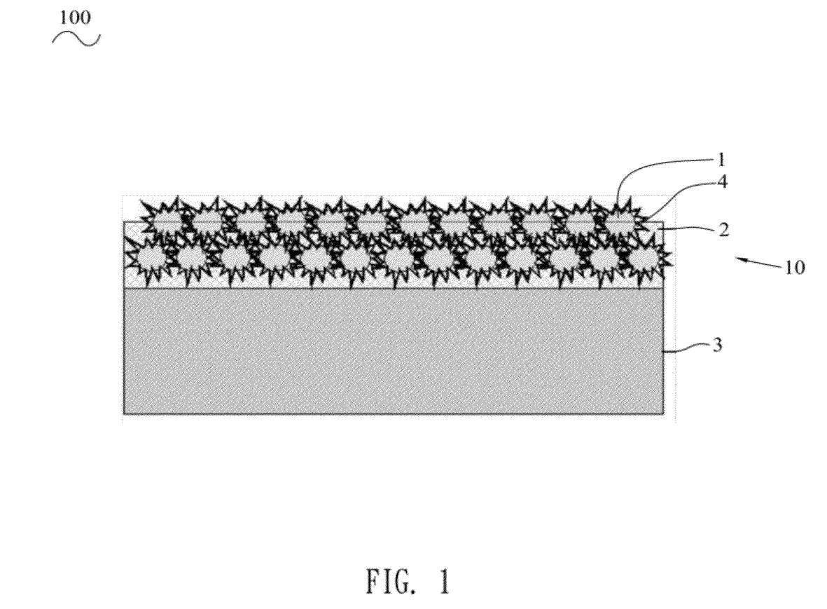

Referring to FIG. 1, a method of manufacturing an anti-fingerprint paint in according to the present invention includes the following steps. Firstly, blend 0.1% to 0.5% fluorinated polymer with 99.5% to 99.9% fluorocarbon solvents to form fluorocarbon polymer paint. Secondly, blend 10 grams of nano-particles 1 with a diameter of 5 to 20 nanometers with 100 milliliters of the fluorocarbon solvents, then add 0.05 to 0.2 grams of fluorine-couplant 2 into the fluorocarbon solvents with the nano-particles 1, and mix up the above-mentioned solvents under room temperature for 24 hours to make an outside surface of each of the nano-particles 1 dressed up by a layer of fluorinated molecules 4 so as to get a nano-particle solvent with the fluorinated molecules 4 dressed around the nano-particles 1. Lastly, blend 900 milliliters of the fluorocarbon polymer paint with 100 milliliters of the nano-particle solvents, and mix up the mixture of the fluorocarbon polymer paint and the nano-particle solvents under the room temperature for 12 to 24 hours to form the anti-fingerprint paint.

Referring to FIG. 1, the nano-particle 1 may be a metallic oxide, such as: TiO2, SiO2, Al2O3, ZrO2; or a metal, such as: Au, Silver, Brass and so on; or a polymer material, such as: PS, PMMA and so on; or a carbon capsule.

Referring to FIG. 1, an anti-fingerprint product 100 in accordance with an embodiment of the present invention includes a substrate 3 and an anti-fingerprint coating 10 covered on a surface of the substrate 3.

Referring to FIG. 1, specific steps of a method of forming the anti-fingerprint coating 10 onto the surface of the substrate 3 are described as following. At first, the anti-fingerprint paint is coated onto the surface of the substrate 3 by means of dipping, wherein a proper functional base can be provided by the fluorine-couplant 2 of the anti-fingerprint paint according to a material of the surface of the substrate 3. The nano-particles 1 with the diameter of 5 to 20 nanometers can achieve a continuous and strict regular-arrayed spatial structure. Then, heat the anti-fingerprint paint coated on the surface of the substrate 3 under 80 to 120 centigrade degrees for 0.5 to 2 hours, or air dry the anti-fingerprint paint on the surface of the substrate 3 under the room temperature for 24 to 48 hours, to make the functional base of the fluorine-couplant 2 and the surface material of the substrate 3 realize a chemical bonding so as to form the anti-fingerprint coating 10 on the surface of the substrate 3.

Referring to FIG. 1, the anti-fingerprint coating 10 contains the nano-particles 1 dressed up by the fluorinated molecules 4 and the fluorine-couplant 2. The anti-fingerprint coating 10 has a thickness of about 10 to 50 nanometers. The substrate 3 may be made of glass, metal, ceramic material or polymer. The substrate 3 may be a shell or a touching screen of an electronic apparatus, such as a cell phone screen, a computer screen, a portable digital assistant (PDA) screen, an industrial computer screen, a camera screen, an ATM screen and other objects which can realize a touching operation.

Referring to FIG. 1, in this embodiment, the nano-particle 1 is a silica nano-particle. The silica nano-particles can achieve a strict regular-arrayed spatial structure. So, after coating the anti-fingerprint paint on the surface of the substrate 3 to form the anti-fingerprint coating 10, the anti-fingerprint coating 10 achieves double anti-fingerprint effect because of the strict regular-arrayed spatial structure of the nano-particles 1. Moreover, surface energies of the fluorinated polymer, fluorine atoms of the fluorine-couplant 2, and the fluorinated molecules 4 dressing up the nano-particles 1 are so low that the anti-fingerprint coating 10 has better hydrophobic and oleophobic characteristics. As a result, the anti-fingerprint product 100 realizes an anti-fingerprint effect.

As described above, the fluorinated polymer, the fluorine atoms of the fluorine-couplant 2, and the fluorinated molecules 4 dressing up the nano-particles 1 have low surface energies, and the strict regular-arrayed spatial structure of the nano-particles 1 achieves a spatial barrier, so that sweat or grease on fingers of a user is not liable to be adhered to the surface of the substrate 3. Therefore, a fingerprint of the user is prevented from being imprinted on the surface of the substrate 3. Furthermore, the methods of manufacturing the anti-fingerprint paint and forming the anti-fingerprint coating 10 on the substrate 3 are simple and further applied to the shells and screens of the electronic apparatus, and no expensive and special equipments are needed. So, the anti-fingerprint product 100 has a lower manufacture cost and is apt to be mass manufactured.

What is claimed is:

1. A method of manufacturing an anti-fingerprint paint, comprising the steps of:
blending fluorinated polymer with fluorocarbon solvents to form fluorocarbon polymer paint;
blending nano-particles with the fluorocarbon solvents, then adding fluorine-couplant into the fluorocarbon solvents with the nano-particles therein, and further mixing up the above-mentioned solvents to get a nano-particle solvent with an outside surface of each of the nano-particles dressed up by a layer of fluorinated molecules; and
blending the fluorocarbon polymer paint with the nano-particle solvents, and further mixing up the mixture of the fluorocarbon polymer paint and the nano-particle solvents under a room temperature for 12 to 24 hours to form the anti-fingerprint paint.

2. The method of manufacturing the anti-fingerprint paint as claimed in claim 1, wherein the nano-particle has a diameter of 5 to 20 nanometers.

3. The method of manufacturing the anti-fingerprint paint as claimed in claim 1, wherein the nano-particle is a metallic oxide.

4. The method of manufacturing the anti-fingerprint paint as claimed in claim 1, wherein the nano-particle is a metal.

5. The method of manufacturing the anti-fingerprint paint as claimed in claim 1, wherein the nano-particle is a polymer material.

6. The method of manufacturing the anti-fingerprint paint as claimed in claim 1, wherein the nano-particle is a carbon capsule.

7. A method of forming an anti-fingerprint coating onto a surface of a substrate, comprising the steps of:
coating the anti-fingerprint paint of claim 1 onto the surface of the substrate; and
heating the anti-fingerprint paint coated on the surface of the substrate under 80 to 120 centigrade degrees for 0.5 to 2 hours, or air drying the anti-fingerprint paint coated on the surface of the substrate for 24 to 48 hours, to make a functional base of fluorine-couplant in the anti-fingerprinted paint and a surface material of the substrate realize a chemical bonding so as to form the anti-fingerprint coating on the surface of the substrate.

8. The method of forming the anti-fingerprint coating onto the surface of the substrate as claimed in claim 7, wherein the anti-fingerprint coating contains nano-particles dressed up by fluorinated molecules and the fluorine-couplant.

9. The method of forming the anti-fingerprint coating onto the surface of the substrate as claimed in claim 8, wherein the nano-particle has a diameter of 5 to 20 nanometers.

10. The method of forming the anti-fingerprint coating onto the surface of the substrate as claimed in claim 8, wherein the nano-particle is a metallic oxide, a metal, a polymer material or a carbon capsule.

11. The method of forming the anti-fingerprint coating onto the surface of the substrate as claimed in claim 7, wherein the anti-fingerprint paint is coated on the surface of the substrate by means of dipping.

12. The method of forming the anti-fingerprint coating onto the surface of the substrate as claimed in claim 7, wherein the substrate is made of glass, metal, ceramic material or polymer.

13. The method of forming the anti-fingerprint coating onto the surface of the substrate as claimed in claim 7, wherein the substrate is a shell or a touching screen of an electronic apparatus.

14. The method of forming the anti-fingerprint coating onto the surface of the substrate as claimed in claim 7, wherein the anti-fingerprint coating has a thickness of 10 nm to 50 nm.
